(19) United States
(12) Patent Application Publication
(10) Pub. No.: US 2017/0214646 A1
(43) Pub. Date: Jul. 27, 2017

(54) SYSTEMS AND METHODS FOR PROVIDING SOCIAL MEDIA LOCATION INFORMATION

(71) Applicant: Co Everywhere, Inc., New York, NY (US)

(72) Inventors: Anthony Longo, Boston, MA (US); Daniel Alan Adams, Melrose, MA (US)

(73) Assignee: Co Everywhere, Inc., New York, NY (US)

(21) Appl. No.: 15/257,660

(22) Filed: Sep. 6, 2016

Related U.S. Application Data
(63) Continuation-in-part of application No. 14/610,071, filed on Jan. 30, 2015.
Application No. 14/610,071 is a continuation-in-part of application No. 14/572,270, filed on Dec. 16, 2014.
Application No. 14/572,270 is a continuation-in-part of application No. 14/610,312, filed on Jan. 30, 2015.
Application No. 14/610,312 is a continuation-in-part of application No. 14/572,270, filed on Dec. 16, 2014.
Application No. 14/572,270 is a continuation-in-part of application No. 14/572,270, filed on Dec. 16, 2014.
(60) Provisional application No. 62/214,393, filed on Sep. 4, 2015.
(60) Provisional application No. 61/995,015, filed on Apr. 1, 2014.
(60) Provisional application No. 61/963,849, filed on Dec. 16, 2013.
(60) Provisional application No. 61/963,850, filed on Dec. 16, 2013.
(60) Provisional application No. 61/995,015, filed on Apr. 1, 2014.
(60) Provisional application No. 61/963,849, filed on Dec. 16, 2013.
(60) Provisional application No. 61/963,850, filed on Dec. 16, 2013.
(60) Provisional application No. 61/995,015, filed on Apr. 1, 2014.
(60) Provisional application No. 61/963,849, filed on Dec. 16, 2013.
(60) Provisional application No. 61/963,850, filed on Dec. 16, 2013.

(51) Int. Cl. H04L 12/58; G06F 17/30; G06Q 50/00; H04L 29/08

(52) U.S. Cl. CPC H04L 51/20; H04L 51/32; H04L 67/18; H04L 67/10; H04L 67/306; G06F 17/30241; G06Q 50/01; H04L 63/0272

(57) ABSTRACT

Aspects and embodiments disclosed herein include services, application systems, applications, and methods for providing location information, such as a geographic location, associated with an audience of one or more authors of social media posts. Additional aspects and embodiments include services, application systems, applications, and methods, for determining a sentiment associated with one or more Emojis included in a social media post having a geographic location. Other aspects and embodiments include services, application systems, applications, and methods, for determining author information for authors within an audience based on one or more Emojis included within a social media post.

### RELATED APPLICATIONS

This application is a continuation-in-part of and claims priority under §120 to U.S. patent application Ser. No. 14/610,312, entitled “USER INTERFACE FOR PROVIDING GEOGRAPHICALLY DELINEATED CONTENT,” filed Jun. 30, 2015; U.S. patent application Ser. No. 14/610,071, entitled “SYSTEMS AND METHODS FOR ENRICHING GEOGRAPHICALLY DELINEATED CONTENT,” filed Jan. 30, 2015; and U.S. patent application Ser. No. 14/572,270, entitled “SYSTEMS AND METHODS FOR PROVIDING GEOGRAPHICALLY DELINEATED CONTENT,” filed Dec. 16, 2014. This application is a non-provisional of and claims priority under 35 U.S.C. §119(e) to U.S. Provisional Patent Application Ser. No. 62/214,369 entitled “USER INTERFACE FOR PROVIDING GEOGRAPHICALLY DELINEATED CONTENT,” filed Sep. 4, 2015, all of which applications are herein incorporated by reference in their entirety. U.S. patent application Ser. No. 14/610,312 is a Continuation in Part of and claims priority under §120 to U.S. patent application Ser. No. 14/572,270, entitled “SYSTEMS AND METHODS FOR PROVIDING GEOGRAPHICALLY DELINEATED CONTENT.” U.S. patent application Ser. No. 14/610,312 also claims priority under 35 U.S.C. §119(e) to U.S. Provisional Patent Application Ser. No. 61/995,015 entitled “METHODS FOR GEOGRAPHIC DELINEATION,” filed on Apr. 1, 2014; U.S. Provisional Patent Application Ser. No. 61/963,850 entitled “CONTENT PROVISION BY GEOGRAPHIC DELINEATION,” filed on Dec. 16, 2013; and U.S. Provisional Patent Application Ser. No. 61/963,849 entitled “METHODS OF GEOGRAPHIC DELINEATION,” filed on Dec. 16, 2013, all of which applications are herein incorporated by reference in their entirety. U.S. patent application Ser. No. 14/610,071 is a Continuation in Part of and claims priority under §120 to U.S. patent application Ser. No. 14/572,270, entitled “SYSTEMS AND METHODS FOR PROVIDING GEOGRAPHICALLY DELINEATED CONTENT.” U.S. patent application Ser. No. 14/610,071 also claims priority under 35 U.S.C. §119(e) to U.S. Provisional Patent Application Ser. No. 61/995,015 entitled “METHODS FOR GEOGRAPHIC DELINEATION,” filed on Apr. 1, 2014; U.S. Provisional Patent Application Ser. No. 61/963,850 entitled “CONTENT PROVISION BY GEOGRAPHIC DELINEATION,” filed on Dec. 16, 2013; and U.S. Provisional Patent Application Ser. No. 61/963,849 entitled “METHODS OF GEOGRAPHIC DELINEATION,” filed on Dec. 16, 2013, all of which applications are herein incorporated by reference in their entirety. U.S. patent application Ser. No. 14/572,270 claims priority under 35 U.S.C. §119(e) to U.S. Provisional Patent Application Ser. No. 61/995,015 entitled “METHODS FOR GEOGRAPHIC DELINEATION,” filed on Apr. 1, 2014; U.S. Provisional Patent Application Ser. No. 61/963,850 entitled “CONTENT PROVISION BY GEOGRAPHIC DELINEATION,” filed on Dec. 16, 2013; and U.S. Provisional Patent Application Ser. No. 61/963,849 entitled “METHODS OF GEOGRAPHIC DELINEATION,” filed on Dec. 16, 2013, all of which applications are herein incorporated by reference in their entirety.

### BACKGROUND

There are many companies that provide, consume, and transfer social networking information via the Internet, such as Twitter, Facebook, MySpace, LinkedIn, Pinterest, Foursquare, Yelp, and Tripadvisor, among others. Social networking sites allow individuals to access social media content related to business and commerce, as well as personal needs and desires. Content often includes text, photographs, videos, and audio files. Also, some social media content providers provide location-based capabilities such as, for example, permitting a user to perform actions based on location. For example, within one type of location-based social network, users are permitted to perform a “check-in” to particular locations, including venues such as businesses, retail locations, events, points of interest, or other locations. A check-in generally includes a process that identifies the user with a particular location at a given time, and may be recorded over time. Accordingly, location-based social networks permit users to find venues of interest, find content of interest, interact with friends, and leave comments regarding particular locations, among other functions.

### SUMMARY

At least one aspect is directed to computer system including an interface configured to receive an input defining at least one audience, a location-based service including a distributed computer system having at least one processor in data communication with the interface; a delineation component adapted to aggregate geographically delineated content including a plurality of social media posts each generated by an author based at least in part on the input defining at least one audience, and wherein each post has an associated geographic location, a relation component adapted to identify a geographic location associated with the audience based at least in part on the geographically delineated content, and a communication component adapted to provide the identified geographic location.

In at least one embodiment, the geographic location includes a plurality of geographic locations. In one embodiment, the system is configured to receive and index the geographically delineated content based the associated geographic location of each social media post. In one embodiment, the computer system may further include an enrichment component to aggregate author profile information based at least in part on the input defining at least one audience. In a further embodiment, the relation component is further adapted to identify the geographic location associated with the audience based at least in part on the author profile information.

According to one embodiment, the input defining at least one audience includes a personality type. In one embodiment, the input defining at least one audience includes author characteristics. According to one embodiment, the computer system may further include an influencer component adapted to determine influencer information for the geographic location. In one embodiment, the audience includes at least one author.

According to one aspect, provided is computer-executed method including receiving an input defining at least one audience, aggregating geographically delineated content including a plurality of social media posts each generated by an author based at least in part on the input, wherein each post has an associated geographic location, identifying a geographic location associated with the audience based at least in part on the geographically delineated content, and providing the identified geographic location.

In one embodiment, the geographic location includes a plurality of geographic locations. According to one embodiment, the computer-executed method may further include receiving geographically delineated content and indexing the geographically delineated content based on the associated geographic location of each social media post. In one embodiment, the computer-executed method may further include aggregating author profile information based at least in part on the input defining at least one audience. In a further embodiment, identifying the geographic location associated with the audience is further based on the author profile information.

According to one embodiment, the input defining at least one audience includes a personality type. In one embodiment, the input defining at least one audience includes author characteristics. According to one embodiment, the computer-executed method may further include determining influencer information for the geographic location. In one embodiment, the audience includes at least one author.

According to one aspect, provided is a computer system including an interface configured to receive an input defining a geographic location, a location-based service including a distributed computer system having at least one processor in data communication with the interface, a delineation component adapted to aggregate geographically delineated content for an audience within the geographic location, the aggregated geographically delineated content including a plurality of social media posts each generated by an author within the geographic location, an enrichment component adapted to identify social media posts of the plurality of social media posts including a first Emoji, and a trend component adapted to determine a sentiment associated with the first Emoji based on the at least content associated with the identified social media posts including the first Emoji.

According to another aspect, provided is a computer system including an interface configured to receive an input defining a geographic location, a location-based service including a distributed computer system having at least one processor in data communication with the interface, a delineation component adapted to aggregate geographically delineated content for an audience within the geographic location, the aggregated geographically delineated content including a plurality of social media posts each generated by an author within the geographic location, and an enrichment component adapted to identify one or more Emoji associated with individual media posts of the plurality of media posts, and determine author information for author within the geographic location based at least on the identified one or more Emoji. In one embodiment, the author information includes at least demographic information.

According to one aspect, provide is a computer system comprising an interface configured to receive an input defining at least one topic of geographically delineated content, a location-based service including a distributed computer system having at least one processor in data communication with the interface, a delineation component adapted to aggregate geographically delineated content including a plurality of social media posts each generated by an author based at least in part on the input defining at least one topic, and wherein each post has an associated geographic location, a relation component adapted to identify a geographic location associated with the audience based at least in part on the geographically delineated content, and a communication component adapted to provide the identified geographic location.

Still other aspects, examples, and advantages of these exemplary aspects and examples, are discussed in detail below. Moreover, it is to be understood that both the foregoing information and the following detailed description are merely illustrative examples of various aspects and examples, and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 is a block diagram showing a location-based service and system suitable for incorporating various aspects of the present invention;

FIG. 2 is a block diagram showing an example process for identifying a geographic location, according to various examples;

FIG. 3 shows one example of a visualization of an identified geographic location, according to various examples;

FIG. 4 is a block diagram showing an example process for determining sentiment, according to various examples;

FIG. 5 shows an example process flow for determining author information, according to various examples;

FIG. 6 shows an example computer system with which various aspects of the invention may be practiced; and

FIGS. 7-10 show example user interfaces, according to various examples.

### DETAILED DESCRIPTION

Aspects and embodiments disclosed herein include services, application systems, applications, and methods for providing location information, such as a geographic location, associated with an audience of one or more authors of social media posts. Additional aspects and embodiments include services, application systems, applications, and methods, for determining a sentiment associated with one or more Emojis included in a social media post having a geographic location. Other aspects and embodiments include services, application systems, applications, and methods, for determining author information for authors within an audience based on one or more Emojis included within a social media post. While traditional social media platforms offer tools that allow users to generate social media posts and exchange information, content, and ideas, substantial challenges still exist in finding those authors posting the most relevant or desired content. It is appreciated that there is substantial value in improved methods and systems for locating relevant authors of social media posts. In particular, such methods and systems permit personalized advertisements, offers, solicitations, and notifications, as well as, improved relationships between one or more social media users, improved connections between social media users, more accurate and relevant information, and generally an improved social media user experience.

For example, such a system that aggregates and indexes social media content having an associated geographic location (i.e., geographically delineated content) may be adapted to analyze content in order to determine a geographic location associated with a particular author, or audience. Such a system may generate advertisements, instruct an advertising system to generate advertisements, or instruct a content provider to generate advertisements, based on the determined geographic location. Furthermore, the system may analyze and determine one or more influencers that influence decisions that particular authors within that geographic location make. Such a system may instruct an advertising system or content provider to generate and send advertisements to the one or more identified influencers.

In various embodiments, systems described herein may receive geographically delineated content from one or more social media content providers. As used herein, geographically delineated content can include social media content or social networking information that is relevant to one or more geographic locations. In various embodiments, geographically delineated content includes a plurality of social media posts (referred to herein as “posts” or “media posts”). Each post is respectively generated by an author, which may include a user or client, through a social media content provider. For example content can include text, photographs, videos, hyperlinks, audio files, among other data types. In particular, social media posts may include one or more Emoji. As used herein, Emojis may include any ideogram, stylized representation of a face (e.g., smiley), or graphic symbol that represents an idea or concept. For example, genres of Emojis may include facial expressions, places and types of weather, animals, and objects. Content can be generated through one or more social media content providers, online repositories of information, or any other provider of location-based relevant content. Although social media content providers, as described herein, include social media platforms such as Twitter, Facebook, MySpace, LinkedIn, Pinterest, Foursquare, Yelp, and Tripadvisor, in further embodiments, providers can include any social media content provider as is understood in the art (including any media that is produced by a human (user generated content), which may not necessarily be considered social media content or platforms).

Content is generated by any source of content such as social media platform users, companies, or any other source of social media content. Sources of content may permit an author to generate individual media posts including text, image content, hyperlinks, audio files, hashtags, likes, dislikes, @mentions, image content, tagged venues/places, Emojis, and author information including: age, sex, topic interests, and domicile. For example, a media post may include a tweet having an avatar, a username, the author's name, a number of likes, the date of the media post, a photograph, and one or more hashtags. Authors may include any person or entity that composes a social media post.

Content may be stored by one or more computer systems. One aspect of the disclosure relates to an improved computer system that aggregates, indexes, and locates social media content. Certain aspects relate to user interface functions that permit a user to more efficiently locate and navigate such content.

In various aspects, geographic locations associated with media posts can refer to a country, a state, a city, a neighborhood, a building, a venue, an address, coordinates such as longitude and latitude, or any other information descriptive of a location. Although geographic location as used herein includes a single geographic location, in various embodiments, geographic location can include a plurality or a series of locations. In various embodiments, media posts within geographically delineated content include an attached (“tagged”) geographic location.

As described above, in some embodiments this can include a “check-in” to particular locations, including venues such as businesses, retail locations, events, points of interest, or other locations. A check-in generally includes a process that identifies the author with a particular location at a given time, and may be recorded over time. In other embodiments, the geographically delineated content is automatically tagged with a geographic location. For example, geographically delineated content generated from a content provider device having a Global Positioning System (“GPS”) may automatically embed location information in the generated content.

In further embodiments, a social media platform may allow an author to manually enter location information. While some content providers may not provide a location with generated content, location may still be inferred from intrinsic information, such as metadata associated with the content. It should be appreciated that geographically delineated content should not be limited to content tagged with a geographic location in any particular manner. Accordingly, it is appreciated that various media posts and types of content will not have location information inherently associated therewith. As such, conventional systems cannot search and provide such information by geographic location. According to one aspect of the present invention, a system may be provided that enhances such information to include additional information that can be inferred by analyzing other content that is determined to be related to the media post not having a geographic location. In this way, metadata associated with content may be improved over the original posted versions.

As described herein, influencers may include individuals, characters, groups, organizations, businesses, and any other entity that has the power to effect actions or inactions taken by another as a result of their perceived relationship, authority, knowledge, status, position, association, or charisma. While influencers are described herein primarily in the context of influencing purchasing decisions, in various implementations influencers may include those who influence any action or inaction, such as attending an event, accessing information (e.g., news articles and educational material), performing an activity, and etc. In particular, various influencers described herein include social media influencers having a social media reputation or influence.

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” “having,” “containing,” “involving,” and variations thereof herein is meant to encompass the items listed thereafter and equivalents thereof as well as additional items.

Moreover, it is to be understood that both the foregoing information and the following detailed description are merely illustrative examples of various aspects and embodiments of the present invention, and are intended to provide an overview or framework for understanding the nature and character of the claimed aspects and embodiments. Any embodiment disclosed herein may be combined with any other embodiment in any manner consistent with at least one of the aspects disclosed herein, and references to “an embodiment,” “some embodiments,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. The appearance of such terms herein is not necessarily all referring to the same embodiment.

Furthermore, in the event of inconsistent usages of terms between this document and documents incorporated herein by reference, the term usage in the incorporated references is supplementary to that of this document; for irreconcilable inconsistencies, the term usage in this document controls. In addition, the accompanying drawings are included to provide illustration and a further understanding of the various aspects and examples, and are incorporated in and constitute a part of this specification. The drawings, together with the remainder of the specification, serve to explain principles and operations of the described and claimed aspects and examples.

### Location-Based Systems and Processes

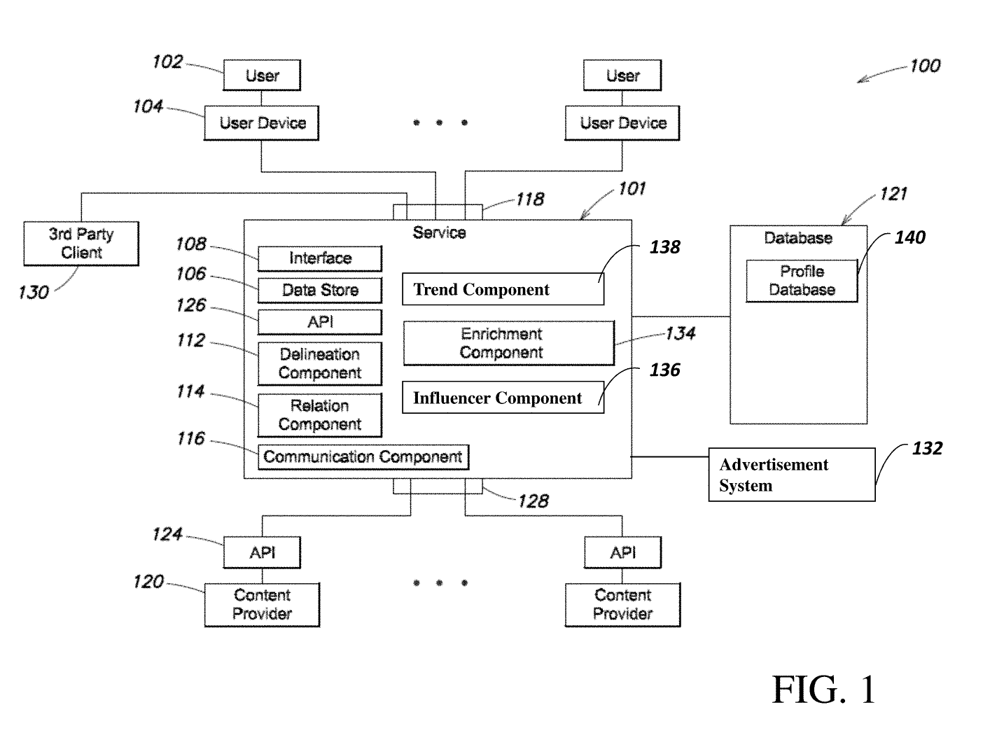

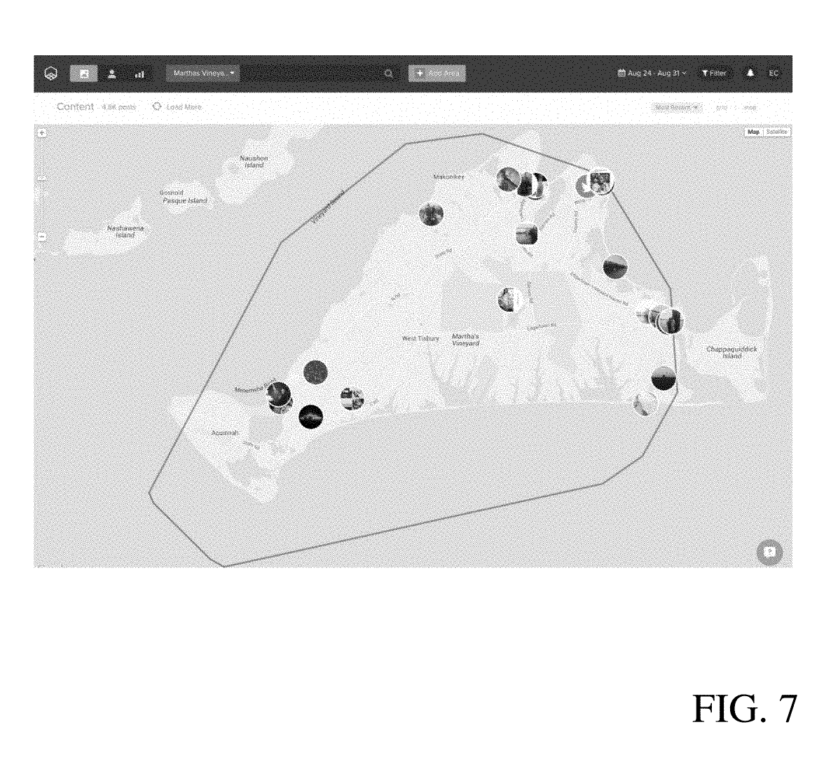

Turning now to FIG. 1, a block diagram of a location-based service and system suitable for incorporation of various aspects of the present invention is shown. For instance, the service 101 may permit one or more users (e.g., user 102) to request and receive geographic location information, such an identification of a geographic location, based on an input defining an audience or a topic. The identified geographic location may include a city, town, country, neighborhood, state, building, or any other information descriptive of a geographic location. In various embodiments, the identified geographic location is associated with geographically delineated content including a plurality of social media posts each generated by an author within the identified geographic location. In further embodiments, the service 101 may also permit a user 102 to find an influencer for the identified geographic location. In one example, such features permit the service 101, or an advertisement system 132 in communication with the service 101, to generate and tailor advertisements to targeted users, authors, an audience, or influencers. In various embodiments, geographically delineated content, author information, and/or influencer information, may be provided to the user 102 in addition to the identified geographic location. Such content and information may be provided in a visual display permitting the user 102 to filter, sort, navigate, and otherwise interact with the content, information, and identified geographic location in a more efficient way. In at least one implementation, content and information may be displayed on an image of the geographic location, such as a map visualization, and in one or more user interfaces as discussed below with reference to FIGS. 7-10.

As shown, in one embodiment, the system 100 can include a computing device (e.g., user device 104) having a memory, a user interface, and one or more processors. For example, the user device 104 can include a cell phone, smart phone, PDA, tablet computer, laptop, or other computing system. Users 102 may use the interface of the user device 104 for interacting with the system 100. In other embodiments, the service 101 may permit one or more third party client systems (e.g., client 130) to request and receive a geographic location associated with an author, audience, or topic having desired characteristics.

In one embodiment, the service 101 may include one or more components. Such components may be implemented using one or more computer systems. In one embodiment, service 101 may be implemented on a distributed computer system using one or more communication networks (e.g., the Internet). In one implementation, the service is implemented in a cloud-based computing platform, such as the well-known EC2 platform available commercially from Amazon.com, Seattle, Wash. Other implementations are possible and are within the scope and spirit of the invention, and it is appreciated that other platforms may be used.

Service 101 may include a webserver which is capable of serving as a front end to the location-based service 101. User devices 104 and/or clients 130 may receive and display an identified geographic location and geographically delineated content, author information, and/or influencer info associated with the identified geographic location provided by the service 101. Notably, devices 104 and clients 130 may include controls that perform various functions in an application (e.g., a mobile application). Further, such devices 104 and clients 130 provide an input generated by the user 102 or the client 130. The user, or client, input may be used to perform one or more functions, such as defining an audience or defining a topic. As used herein, an audience may include one or more authors of social media posts.

Services may be integral to service 101 or may alternatively operate in conjunction with service 101 (e.g., by communicating with the service 101 through an Application Programming Interface (API)). In some implementations, the service 101 is configured to execute one or all of a plurality of components including a delineation component 112, a relation component 114, a communication component 116, an enrichment component 134, a trend component 138, and an influencer component 136. In further embodiments, the service 101 may include means for performing any or all of the processes described herein. Component may be implemented using specialized hardware, software, or a combination thereof.

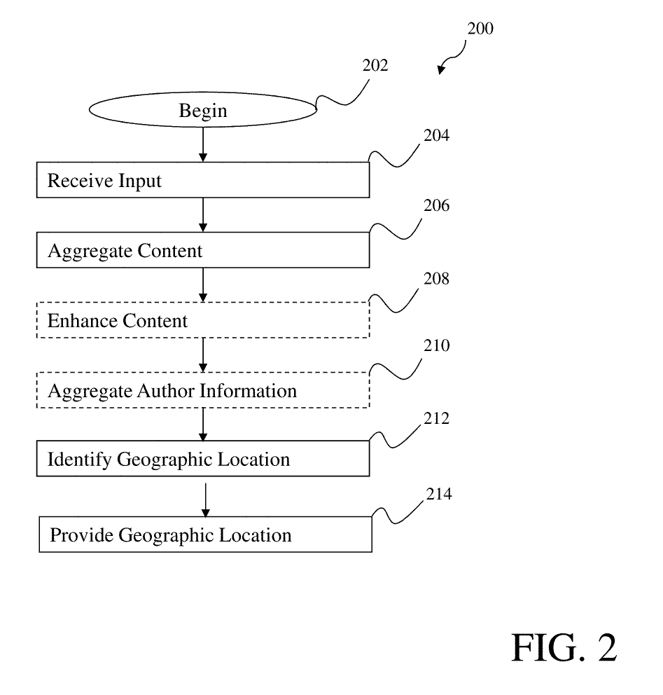

With continuing reference to FIG. 1, FIG. 2 shows an example computer-executed process (e.g., process 200) in accordance with at least one embodiment. At block 202, the process 200 begins. At block 204 an input is received from a user or a client over a network 118. The interface 108 of the service 101 is configured to receive from the user device 104, or the client 130, the at least one input. In one embodiment, the input defines an audience for which to aggregate content and identify a geographic location. As used herein, an audience may include one or more authors. In further embodiments, the input defines at least one topic of geographically delineated content for which to aggregate content and identify a geographic location.

In particular implementations, the input may include at least one author characteristic corresponding to author information associated with social media content authors. The author characteristic may include any particular bit of author information. As discussed above, author information may include any information descriptive of an author of social media content, such as any information describing an author on a social media platform. For example, author information may include: the author's display name, the author's username, the location of the author, the author's website, the author's biography, the author's source application URL, the author's following count, a count of how many authors are following the author (i.e. follower count), the names of those the author is following, the author's total post count, the author's post count in a geographic location, how many impressions the author has, the author's influence score, age, gender, interests, domicile, occupation, date of birth, the school that the author has or is attending, the author's relationship status, approximate income, and recent activity, travel history, to name a few. The input may include a natural language-based identification of an author characteristic (e.g., keywords) or a selection from a list of author characteristics. In various embodiments, the input defines the audience for which a geographic location is desired.

For example, the user interface may be configured to receive as an input: “Gender=male”, “Age=20-39”, “Income=$50 k-$100 k”, and “Interest=Sailing.” The service 101 may be further configured to make adjustments or suggestions to an input responsive to receiving the input. Such implementations permit the user to define the most accurate and relevant request for a geographic location. In another example, the input includes an author characteristic descriptive of personality type. For instance, the personality type may include a Myer-Briggs Type Indicator. In such an embodiment, the input defines the audience for which a geographic location is desired based at least on a measure of psychological preferences in how authors of social media content make decisions. In one particular implementation, the input permits the user 102 or client 130 to direct the service 101 to identify a geographic location for an audience consisting of “decision makers” having desired author characteristics. For example, the user interface may be configured to receive as an input; “Decision makers and vacation rentals.” Such an input would result in identification of geographic locations at which one or more authors have created social media posts regarding a decision to pursue a vacation rental.

In further embodiments, the input may define at least one topic of geographically delineated content. The topic permits the user 102, or client 130, to specify the type or topic of geographically delineated content for which to identify a geographic location. In various embodiments, the service 101 receives a selection of one or more predetermined topics provided to the user 102 or client 130. The predetermined topics may include a list or arrangement of uniform topics permitting the service 101 to analyze media posts based on natural language processing, machine learning, computer vision, or other processing techniques. Accordingly, uniform topics across one or more processing techniques improve the speed and the efficiency of the service. That is, geographically delineated content of different formats, and including different types of social media posts, may all be analyzed based on a uniform topic classification.

In one embodiment, the service 101 may store information for each particular user or client, including inputs or preferences. Specifically, after receiving the input via the interface 108, the user 102 or client 130 may activate a save indicator prompting the service 101 to store the entered input at a data store 106. In further embodiments, the service 101 may store author information, influencer information, or geographically delineated content for a geographic location responsive to user input indicating that such content and/or information should be saved. In various embodiments, the user 102 or client 130 can label or otherwise “name” stored data or information. Stored inputs can be associated with user accounts and recalled from the data store 106. For example, the service 101 can be configured to associate a stored input with a unique identifier associated with a user or client account. The service 101 can then be configured to identify a geographic location relating to the unique identifier.

It is appreciated that users of the systems, methods, and services described herein may be interested in the same type of location information over periods of time, for example, the user 102, or client 130, may make the same request for a geographic location three times a week. This is often the case as geographic locations associated with relevant authors may change, or drift over time. For instance, there may be a large concentration of authors interested in running in the Boston, Mass., geographic location during the summer months; however, during the winter months the concentration may be reduced. Accordingly, the service 101 permits the user 102, or client, to store entered inputs for efficiency and convenience.

At block 204, a website or application (e.g., application executing on the user device 104) may be displayed to the user 102. Alternatively, an interface such as an API (e.g., API 126) may be provided to an application for providing the input to another application or system, such as the client 130. As discussed above, the input may be received at the interface 108 of the service 101. Also, the input may be received from a third party application or system that utilizes location-based services.

A component within the service 101 is configured to communicate with at least one source of content, such as a content provider 120, and/or a database (e.g., database 121) to perform a query. In various embodiments, the system 100 may include a plurality of databases, each database storing geographically delineated content, author information, or influencer information. While in one embodiment performing a query includes requesting social media content from a content provider, (e.g., Twitter), in other embodiments it includes requesting content from the database 121. Content and information may be stored and indexed as further described below.

In one embodiment, responsive to receiving the input, the delineation component 112 generates a query compatible with the one or more content providers 120 or the database 121, based on the input. In various embodiments, this includes generating a query based on an input defining an audience, or an input defining a topic. In one example, the query can be formatted to request geographic delineated content from one or more content provider APIs 124. The APIs 124 associated with one or more content providers 120 permit the exchange of geographic delineated content. However, in other various implementations the delineation component 112 is configured to generate a query for the content provider without using an associated API. It is appreciated that various content provider APIs may have different limitations and accordingly, in various implementations, the query is formatted specifically for each content provider.

The service 101 may also be capable storing information in one or more content databases prior to receiving a user or client input. Such an implementation permits the service 101 to query the database instead of, or in addition to, a content provider. This increases the speed and efficiency of the service 101. For instance, the service 101 may be configured to gather and store geographically delineated content (e.g., location based social media content), such as text, photographs, videos, audio files received from at least one content provider 120, and any author information, continually, periodically, or intermittently. Accordingly, in some examples the service 101 may not need to query the content providers 120 as relevant content and information may be readily available at the database 121. For instance, for a particular geographic region or location, the service 101 may automatically receive a feed of all content for that region or location, and store such information within the database (e.g., database 121).

In one implementation, received content is stored and indexed in a geographic quadrant based storage grid. When visualized, the grid resembles a mesh placed over the planet (e.g., Earth), in which grid lines run parallel to longitude and latitude lines. Accordingly, received geographic content is stored in location-based quadrants related to the tagged location of the content. In other embodiments, geographically delineated content is stored in a time-based grid, in which content is stored based on the time the content was generated by the content provider. In other embodiments, content can be stored in a time-received-based grid, in which content is stored based on the time the geographic content was received by the delineation component. In further embodiments, the received content can be stored in a subject-based grid, in which content is stored based on the source or the type of the geographically delineated content (e.g., Twitter, Facebook, MySpace, LinkedIn, Pinterest, or Tumblr content). It should be appreciated that geographically delineated content can be stored in any other fashion as is suitable for geographically delineated content.

In various embodiments, one or more components of the service 101 are configured to automatically generate datum content responsive to receiving geographically delineated content from one or more content providers 120. For example, datum content may correspond with the source content of each individual media post within the received geographically delineated content. Datum includes a concentration of the bare minimum information necessary to support a search and analysis of stored geographically delineated content. For example, while full image metadata is stored in a source document, the associated datum document only contains a list of metrics, otherwise referred to as feature names, e.g., “author,” “sport,” etc. The datum content reduces the file size and concentrates contents of the datum document to permit the service 101 to efficiently and rapidly convert a query against the datum content and aggregate geographically delineated content. In this way, the speed of queries is improved, and the delineated content may be efficiently aggregated. As understood, file size refers to the amount of space consumed by a file, such as a datum document. Typically, file size is measured in bytes. It should be appreciated that a prohibitively large number of media posts may be generated by multiple users of various social media content providers that could be retrieved by a particular service. Because of the large numbers of items that could be queried, viewed, etc., by a system, a more efficient method of working with such items may be necessary. For instance, even within a defined geography, there may source documents to be processed effectively.

Additionally, maintaining a full set of source content, permits the service 101 to further analyze the source content, debug the process, and perform other maintenance operations. One or more components can additionally be configured to denormalize key information into the datum content to optimize queries and analysis, for example, author information including username, follower count, avatar, author bio, etc. Such an embodiment permits the service 101 to perform one or more of the aspects discussed below, such as detecting high influence authors or filtering geographically delineated content.

For example, a media post may include all of the information associated with a self-taken Instagram picture posted at Gillette Stadium in Foxborough, Mass. during a professional football game. Generation of the datum document (referred to herein also as story datum) can include analysis of the metadata, information, or other data associated with the post that may suggest the topics, sports, football, rugby, and soccer. However, only “sport” and “football” are included in the datum document, as rugby and soccer are not relevant to a professional football game. The datum document also includes “person”, as included in the picture were facial features.

The datum may also include hashtags, and location information. In one embodiment, the datum may include different types of location information that are indicative of the source of the location information or otherwise indicate how the location information should be used by the system. For instance, as referred to herein, the system may define and use genuine or precise location information. As used herein, genuine location refers to a referential geographic position, such as a venue or store location, and precise location refers to navigational positioning, such as GPS location or longitudinal and latitudinal coordinates. Accordingly, in this example, the datum would include parameters indicating values, such as, for example genuine location true and precise location false. Because the picture was taken at Gillete Stadium, the genuine location is included, but the precise location is not.

Based on the foregoing, the media post may be included in all queries and analysis of geographically delineated content associated with the Gillete Stadium. In various embodiments differentiating between genuine location and precise location can include or exclude media posts displayed in a visual representation. Omitting media posts not having a precise location for a visualization of a geographic location prevents the build-up of artificially inflated “hotspots” of content for a particular discrete point within the identified location. Although described herein generally as aggregating geographically delineated content responsive to querying a geographically delineated content database, in various embodiments, querying a database includes identifying a story datum document and converting the query to return source content including one or more media posts. Datum content may be stored in any manner as described herein, such as in a geographic quadrant based storage grid. It should be appreciated that some or all of this datum content and its functionality may be made available to one or more clients directly, or be provided to a third party system (e.g., via an API).

As such, in various embodiments, the delineation component generates a query compatible with the database 121. As discussed above, in various embodiments the query is based on the input defining an audience or the input defining a topic. Querying database 121, instead of the content providers 120, or in addition to the content providers 120, offers numerous benefits such as improved speed, precision, and accuracy. Furthermore, such process permits content enhancement as is described herein. The delineation component 112 may be configured to query one or more content providers 120 and receive geographically delineated content automatically to ensure an accurate and updated database of content. In one embodiment, the delineation component is configured to continually query content providers for content relative to frequently identified geographic locations. For example, the delineation component 112 can be configured to automatically and continually query and aggregate geographically delineated content from Twitter in the Boston, Mass. location. Automatic queries may be time scheduled, may be random, or may be variable based upon the activity within a particular geographic location. In various embodiments, the frequency and range of automatic queries and aggregations are based on the frequency and/or volume of user or client inputs. In other embodiments, the frequency and range of automatic queries are based on social events (e.g., concerts, sport events, weather, news stories, etc.).

In some embodiments, the delineation component 112 is further configured to delay, postpone, or “put to sleep” automatic queries. For example, the delineation component 112 may delay automatic queries for infrequently requested geographic location. In this regard, the service 101 can determine whether content requested from a particular location will likely be requested, and delay the query and aggregation if necessary. Delay, postponement, and “put to sleep” configurations permit the service 101 to allocate computing resources. Although discussed herein as performed by a delineation component 112, in various other embodiments, querying one or more content providers 120 and aggregating geographically delineated content may be performed by a plurality of components.

At block 206, the delineation component 112 is configured to aggregate the geographically delineated content received from the query. In response to performing the query, the delineation component 112 aggregates the geographically delineated content matching the query. Content may be retrieved from the database 121 and/or one or a plurality of content providers 120, as discussed above, and may be in one or a plurality of formats. Content can include text, photographs, videos, and/or audio files, and in additional embodiments, enrichments. In several embodiments, the relation component 114 is configured to identify at least one geographic location associated with the audience based on the aggregated geographically delineated content. This may include comparing geographic locations associated with each social media post, and providing those geographic locations having the greatest volume. However, in further embodiments, the service 101 may be further configured aggregate author profile information, and identify a geographic location associated with the audience based at least in part on the author profile information, such as a primary location, associated with an author.

In several embodiments, author information includes information associated with an author profile of the author that generated a social media post. Author profiles may be generated by the service 101 and stored in one or more databases, such as a profile database (shown as 140 in FIG. 1). As discussed above, in at least one embodiment the delineation component 112 is configured to continually query content providers for content. Such automatic queries may be independent from queries based on an input defining an audience, and performed to maintain a database of author information. In various embodiments, responsive to receiving geographically delineated content, one or more components of the service 101 are configured to analyze each of the plurality of media posts and determine an author responsible for generating the media post. This can include analyzing any of an avatar, a username, a full name, a bio, a profile picture, or any other characteristic available in a media post or on an author's profile at a platform of a social media content provider. In one embodiment, the enrichment component 134 can be configured to realize an identifier associated with a previously created author profile having author information and other enrichments as described below. For example, in various embodiments this may include identifying a username associated with a social media post. Profiles may include repositories of metadata extracted from previous posts, information available on other social media platforms, and information available from any other appropriate source.

The author information from each media post may be arranged and stored as the author profile. Author profiles, may be generated and updated automatically when the service 101 receives geographically delineated content. For example, in various embodiments, responsive to identifying an author and determining an author profile for that author is not available at the database 121, the service 101 is configured to query one or more social media content providers 120 to determine an avatar, profile photograph, username, full name, bio, website, location, date joined, verification status, activity, number of followers, favorites, education, sentiments, connections, age, employment status, employer, relationship status, date birth for the author, gender, or any other author identifying characteristics for that author. The determined characteristics are added to the information ascertained from the media post and stored in a new author profile accordingly. Author profiles may be uniquely defined in a database (e.g., in database 121).

In various embodiments, one or more components of the service described herein are configured to update the author profile with each media post received. For example, an update may occur when a media post indicates that an author's interests have changed. Furthermore, author profiles may be updated responsive to detecting new information at a user profile on a social media content provider platform. Updates may be performed automatically to ensure accurate and truthful author profile information aggregated from the author profiles. Notably, the author profile provides a centralized repository of author information across all social media content provider platforms. Because an author can be identified across multiple social media platforms, social activity of the author may be more effectively measured in comparison to measuring activity over a single channel (e.g., Twitter).

In some embodiments, no author profile may exist at the database 121 for an author associated with a media post. Often this is the case when a new author is identified. Accordingly, in various embodiments one or more components of the service 101 are configured to generate and store an author profile. Author profiles are generated by aggregating information, data, metadata, and information descriptive of author characteristics. As described above, author information can be ascertained from one or more media posts or a corresponding profile at one or more social media content provider platforms. For example, content providers may include social media and social networking providers such as Twitter, Facebook, MySpace, LinkedIn, Pinterest, Foursquare, Yelp, Tripadvisor, and Tumblr.

Further still, in some embodiments, a media post of the plurality of media posts may not have a profile name, user name, or other author information, from which an associated author may be easily identified. Accordingly, one or more component of the service 101, such as the enrichment component 138, may be configured to further analyze metadata associated with the media post to determine the author profile associated with the author despite the absence of an identifier for the author profile. For example, such an identification may include identifying an @mention or analyzing a photograph to determine facial features of the author. As such, in various embodiments one or more components are configured to analyze information, data, metadata, or meta information associated with the plurality of media posts of the aggregated geographically delineated content to identify an author profile and aggregate author information, such as author profile information.

In one particular embodiment, author information stored at one or more author profiles includes an author characteristic descriptive of personality type. For instance, the personality type may include a Myer-Briggs Type Indicator. Such information may include an indicator based at least on a measure of psychological preferences in how authors of social media content make decisions. In various embodiments, such an indicator is determined based on a history of social media posts for a particular author. One or more components of the service, such as the enrichment component 134 are configured to perform machine learning, such as natural language processing, to associate particular text, characters, or images, with a personality type indicator. For example, in one embodiment the enrichment component 134 is configured to perform text comparison to compare the text of a social media post with a predetermined archive of text known to be associated with a particular personality type. For instance, use of particular words or phrases may be associated with introversion and extraversion, feeling and thinking, intuition and sensing, and any other descriptor of personality type.

Accordingly, at block 210 one or more components of the service 101, such as the enrichment component 134 are configured to generate a query for author information based at least in part on the defined input defining an audience or a topic. While the process shown in FIG. 2, shows both the acts of aggregating geographically delineated content and aggregating author information, in further embodiments, the service 101 may aggregate only author information based on the input, or only geographically delineated content based on the input. In various examples, the query for author information may specify particular author characteristics designated in the input. For example, the query may request from the author profile database, all author information corresponding to authors with an interest in motorcycles and football. Author information for an author profile that matches the query is aggregated by the enrichment component 134. In various embodiments, querying a database of author profiles improves the speed and efficiency of the service 101. Further, it is appreciated that querying an author profile database provides more detailed and accurate information regarding social media content authors.

At block 210, the delineation component is configured to analyze the aggregated geographically delineated content and/or aggregated author information. For example, author information may be extracted from individual media posts of the geographically delineated content, aggregated from author profiles stored at the database 121, or aggregated from one or more author accounts on various social media platforms, such as Twitter, Facebook, MySpace, LinkedIn, Pinterest, Foursquare, Yelp, Tripadvisor and Tumblr, among others. It is appreciated that most social media posts inherently include some author information. For example, most social media posts will at least include a username and an avatar.

At block 212 of FIG. 2, the relation component 114 is configured to identify a geographic location associated with the audience or topic based at least in part on the aggregated geographically delineated content. In further embodiments, the relation component 114 is configured to identify a geographic location associated with the audience or topic based at least in part on aggregated author profile information. In further embodiments still, the relation component 114 may be configured to identify a geographic location associated with the audience based at least in part on aggregated geographically delineated content and aggregated author profile information.

Responsive to aggregating geographically delineated content and/or author profile information based on the input defining the at least one audience or topic, the relation component 114 is configured to identify a geographic location associated with each media post. In one implementation, this includes identifying an attached (“tagged”) location, a “check-in”, or GPS coordinates associated with a social media post. As discussed above, location may include genuine location or precise location. Identifying a geographic location based on aggregated author information may include identifying a geographic location for each particular author within the author information based on a primary location, a geographic location associated with a most recent social media post, a geographic location associated with a history of media posts, or a home or work address of an associated author. In some embodiments, a geographic location associated with a particular media post may not be readily discernable. In such an instance, one or more components of the service 101 may be configured to perform natural language processing, computer vision, or other image processing techniques to analyze metadata associated with a media post to identify a geographic location. For instance, in at least one embodiment, the relation component 114 is configured to identify a geographic location based on an image included in a media post.

Once a geographic location has been associated with each media post of the aggregated geographically delineated content, or author of the aggregated author information, the relation component 114 is configured to analyze and compare the determined geographic locations. It is appreciated that often numerous geographic locations may be identified for an aggregation of geographically delineated content or author information. While in some instances, the user 102 or client 130, may desire each and every identified geographic location, in many instances, this information will have limited use. Accordingly, in at least one implementation the relation component 114 is further configured to identify those geographic locations associated with the largest volume of media posts or authors. For example, responsive to receiving the input: “Gender=male”, “Age=20-39”, “Income=$50 k-$100 k”, and “Interest=Sailing,” the relation component 114 may identify over one hundred geographic locations. These geographic locations may be further analyzed, and the five having the largest volume of media posts, or authors, may be identified as the most relevant geographic locations for the defined audience. While in one embodiment, relation component 114 identifies only the most relevant geographic location, any, or all, of the identified geographic locations may be provided by the service 101.

At block 214 of FIG. 2, the communication component 116 is configured to provide the identified geographic location(s) to the one or more user devices (e.g., user device 104) or clients (e.g., client 130). In further embodiments, the communication component 116 may further provide the aggregated geographically delineated content or aggregated author information associated with the identified geographic location, permitting the respective user or client to view the information and/or geographically delineated content. In further embodiments, the communication component 116 may also distribute user or client generated inputs, author information, or geographically delineated content, to social networking sites, social media content providers, or an advertisement system. As such, various embodiments permit the user 102 or client 130 to find a geographic location based on desired author characteristics or topics. In contrast to conventional social media platforms, such an embodiment permits a client or user to efficiently and accurately locate the most relevant authors posting social media content.

In various embodiments, one or more components of the service 101, for example the enrichment component 134, may enrich (i.e., enhance) geographically delineated content (act 208). In various embodiments, content may be enriched automatically upon receipt from a content provider 120. It is appreciated that enriched aggregated geographically delineated content benefits the user, or client, by permitting real-time access to more content, more relevant content, and detailed social media content across multiple social content provider platforms. Accordingly, users receive more robust and interconnected aggregations of content. Various embodiments also permit more efficient, swift, and detailed user queries to return more relevant content. For example, often media posts received from Twitter will not include a location. In various embodiments, enrichment data including location information may be associated with the Twitter post. As such, users not only receive more detailed information, they will receive content that would not have otherwise been detected or found.

For example, individual media posts of the plurality of media posts may be deconstructed into a plurality of dimensions, such as an author dimension, an image dimension, a content dimension, and a location dimension. Each dimension may be enhanced with enrichment data to provide a more robust aggregation of geographically delineated content. Generally, dimensions include divisions of information, data, and meta information intrinsic to the media post. For example, the author dimension of a media post may include an avatar and a username of the author that generated that media post. One or more components of the service may be configured to automatically aggregate enrichment data related to at least one of the dimensions of each of the individual media posts. In various embodiments, aggregating enrichment data includes analyzing the dimensions of each individual media post. In particular, the enrichment component 134 can be configured to realize an identifier associated with a profile having enrichment data, as discussed above. In addition to author information, profiles may include repositories of other metadata extracted from previous posts and may include venue information, content information, location information, event information, or any other information not provided by the content provider from which the media post is provided.

As discussed herein, enhancing at least one of the individual media posts includes adding, exposing, identifying, or otherwise providing information, data, metadata, or meta information not inherent to the associated media post. It is appreciated that often a content provider 120 will not provide a full story associated with a media post. For example, in various embodiments, enhancing the plurality of media posts includes providing a visualization of enrichment data to present a more robust narrative of the story told by the media post. Enhancing the plurality of media posts, can include providing additional data related to at least one of an author dimension, a content dimension, a location dimension, or an image dimension. In further embodiments, enhancing the aggregated geographically delineated content with enrichment data permits the service to categorically group related media posts that would not have otherwise been identified as related.

In various embodiments, one or more components of the service 101, such as the trend component 138 may be configured to perform one or more processes or algorithms based on at least the author information or aggregated geographically delineated content corresponding to an identified geographic location. For example, the trend component may be configured to generate metrics, detect an incongruity, or provide other statistics regarding the author information or geographically delineated content. In one instance, the trend component is configured to generate an influence score for each author within the identified geographic location. The influence score may include a quantification or visual indication of an influence the particular author has on other authors within the identified geographic location. The influence score may be generated by the trend component 138 based on, for example, a volume of followers, a volume of posts, and an engagement rate.

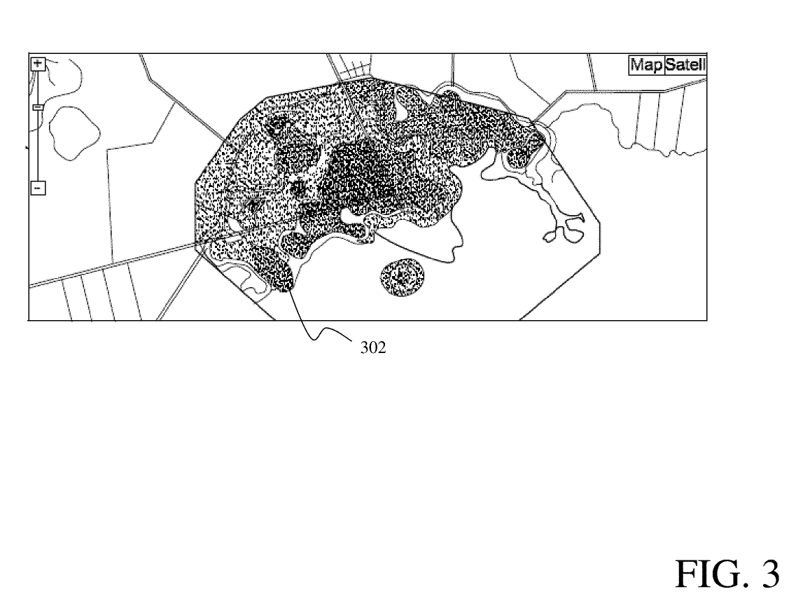

In various embodiments, the relation component 114 may generate a visualization of the identified geographic location. In further embodiments, the visualization may include the aggregated geographically delineated content and/or author information associated with the geographic location. For example, the visualization may include a map of the geographic location, such as a street map, a satellite image, a mass transit map, or any other geographic depiction. In various embodiments the visualization may include a heatmap including a series of indicators representing the aggregated geographically delineated content or author information. The heatmap visualization may further include one or more indicators layered over the image of the geographic location. The indicators are configured to show the density of the volume of the geographically delineated content for the identified geographic location, or a series of locations, on the image and can include but should not be limited to colors, shapes, and images. In one implementation, the heatmap visualization shows a range of colors conveying the volume of social media content in the geographic location to help the user or client understand the geographic layout of social media content or activity. For example, a heatmap visualization for the identified geographic location of Boston, Mass., may show a higher volume of Twitter content in the North End neighborhood than the South End or South Boston neighborhoods. FIG. 3 shows one example of a heatmap visualization. The heatmap visualization of FIG. 3 shows one or more indicators 302. The indicators 302 are configured to show the density of the volume of the geographically delineated content or author information for a discrete spatial area. As shown, the indicators 302 include a range of colors conveying the volume of social media content in the geographic location to help the user or client understand the geographic layout of social media content or activity.

In further embodiments, once a geographic location has been identified and provided, one or more components of the service are configured to provide influencer information for one or more influencers having an impact on authors within the identified geographic location. In various embodiments influencer information may include: the influencer's name, the influencer's display name on a social media platform, the influencer's username, the location of the influencer, the influencer's website, the influencer's biography, the influencer's source application URL, the influencer's follower count, a count of how many authors are following the influencer, a count of how many influencers are following the influencer, the influencer's total post count, the influencer's post count in a geographic location, how many impressions the influencer has, the influencer's influence score, age, gender, interests, domicile, occupation, date of birth, the school that the influencer has or is attending, the influencer's relationship status, approximate income, sponsorships, endorsements, recent activity, travel history, and any connections the influencer has to other influencers, to name a few. While discussed herein in several embodiments as separate from author information, in additional embodiments, author information may include influencer information or influencer information may include author information. For example, influencer information may include author information associated with an author profile of a particular influencer. In at least one example, influencers may be identified and influencer information may be provided based on author interests common among authors for the identified geographic location, one or more shared followings (e.g., an overlapping group of followed authors), or any other appropriate process performed by one or more components of the service 101.

In at least one embodiment, the service 101 is further configured to determine a second geographic location associated with a defined audience or topic, responsive to identifying a first geographic location. For example, various embodiments of the service 101 are configured to find further geographic locations associated with similar geographically delineated content or author information. In one implementation, the delineation component 112 is configured to generate query for geographically delineated content and/or author information based on geographically delineated content corresponding to the identified geographic location. This may include generating a query based on interests or demographic information of authors with the location. The delineation component 112 is configured to query the database 121, an author profile database 140, or one or more content providers 120, and aggregate geographically delineated content or author information that matches the query. Based on the aggregated content or author information, one or more components, such as the relation component are configured to determine a geographic location associated with each media post of the aggregated geographically delineated content or author of the aggregated author information. This location information may be used to identify a second geographic location, similar and related to the first identified geographic location. For example, in one embodiment the delineation component 112 may be configured to generate a query based on the most popular interests for a group of authors within a first identified geographic location. The delineation component 112 may then query the database 121 and receive and aggregate geographically delineated content relating to the most popular interests. The relation component 114 may then analyze individual media posts of the aggregated geographically delineated content to extract location information such as a tagged location, GPS coordinates, or a check-in, corresponding to each media post. This location information may then be provided as a second identification of a geographic location. In various embodiments, this permits the user 102 or client 130 to find geographic locations that otherwise would have gone unnoticed.

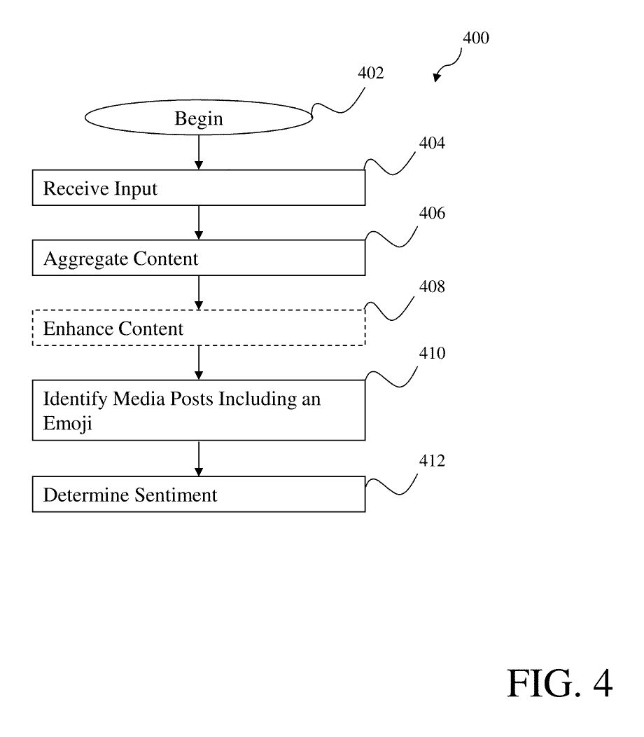

Turning now to FIG. 4, shown is one example process flow for determining sentiment, according to various examples discussed herein. As shown, the computer-executed process may include acts of receiving an input, aggregating geographically delineated content, identifying media posts including an Emoji, and determining sentiment. In further embodiments, the computer-executed process 400 may include the act of enhancing geographically delineated content. In various embodiments, the processes discussed with reference to FIG. 4 may be performed by a service for providing geographically delineated content or identifying a geographic location associated with a defined audience, such as the service 101 discussed above with reference to FIG. 1. FIG. 4 is discussed with continuing reference to FIG. 1.

The process begins at act 402. In act 404, an input is received from a user or client. For example, act 404 may include those processes as described above with reference to act 204 of FIG. 2. In alternative embodiments, the input defines a geographic location for which to aggregate and provide content, author information, or influencer information. For example, the input may include a selection from a list of geographic locations, a selection of a geographic location defined in a visual geographic representation of a geographic location (e.g., a map), or a natural language-based identification of a geographic location (e.g., keywords). For example, the user interface may be configured to receive as an input: a country, a state, a city, a neighborhood, a building, a venue, an address, coordinates such as longitude and latitude, or any other information descriptive of a location. The interface may also be configured to receive a polygon defined in a visual geographic representation of a geographic location.

In one embodiment, responsive to receiving the input, the delineation component 112 generates a query compatible with the one or more content providers 120 or the database 121, based on the geographic location and the query parameters. In further embodiments, such as those discussed above, the delineation component 112 generates a query compatible with the one or more content providers 120 or the database 121 based on the input defining an audience. At block 406, the delineation component 112 is configured to aggregate the geographically delineated content received from the query.

At block 410, one or more components of the service 101 are configured to identify individual media posts of the aggregated geographically delineated content including at least one Emoji. As discussed above, Emojis may include any ideogram, stylized representation of a face (e.g., smiley), or graphic symbol that represents an idea or concept. For example, genres of Emojis may include facial expressions, places and types of weather, animals, and objects. Emoji detection may be performed, for example, by the enrichment component 134. In various embodiments, the enrichment component 134 is configured to search each media post received by the service 101 based on a repository of known Emojis. Any character not corresponding to a character in the repository is deemed not an Emoji. Responsive to identifying a known Emoji, the enrichment component 134 is configured to identify the particular Emoji to which the identified Emoji corresponds. For example, one or more component of the service 101 are configured to identify an Emoji based on text string comparison, image comparison, or text and image object comparison. In various embodiments, the service 101 is configured to restrict identification of an Emoji to a predetermined area of the social media post.

At block 412, one or more components of the service 101 are configured to determine a sentiment associated with an identified Emoji. Sentiments may include any attitude or feeling. For example, sentiments may be positive, negative, or neutral, and be associated with a particular emotion. In one implementation, this may include happy, joyful, surprised, sad, scared, concerned, and etc. According to various embodiments, one or more component of the service 101, such as the trend component 138, is configured to analyze the media post and metadata associated with the media posting including the identified Emoji to determine a sentiment associated with the identified Emoji. In one implementation, more than one Emoji may be identified. In such a case, one or more components of the service may be configured to determine a weight/average Emoji for the particular media post.

It is appreciated that Emojis can provide useful and more detailed information regarding a social media post, or an author that generated a social media post. In particular implementations, such information may be used to tailor advertisements, offers, solicitations, and notifications, as well as, improve relationships between one or more social media users, create connections between social media users, provide more accurate and relevant information, and generally improve a social media user experience. For example, responsive to receiving a social media post including an Emoji, and determining that the Emoji is associated with a “hungry” sentiment, one or more components of the system may generate an advertisement, or provide an instruction to an advertisement system, to provide the author of the social media post with an advertisement for a local restaurant. Such an implementation is particularly advantageous because the geographic location of the user will be known based on the social media post, and the advertisement may be tailored to those restaurants within the current vicinity of the author. Further, in an implementation where author information for the author is readily available, or has been aggregated by one or more components of the service 101, interests or preferences of the author may be identified to further tailor the advertisement. Continuing with the example above, responsive to determining that the Emoji is associated with a “hungry” sentiment, the service 101 may analyze author information for the author of the social media post to determine that the author previously posted that they dislike Italian food. Accordingly, providing an advertisement for a local Italian restaurant can be avoided.

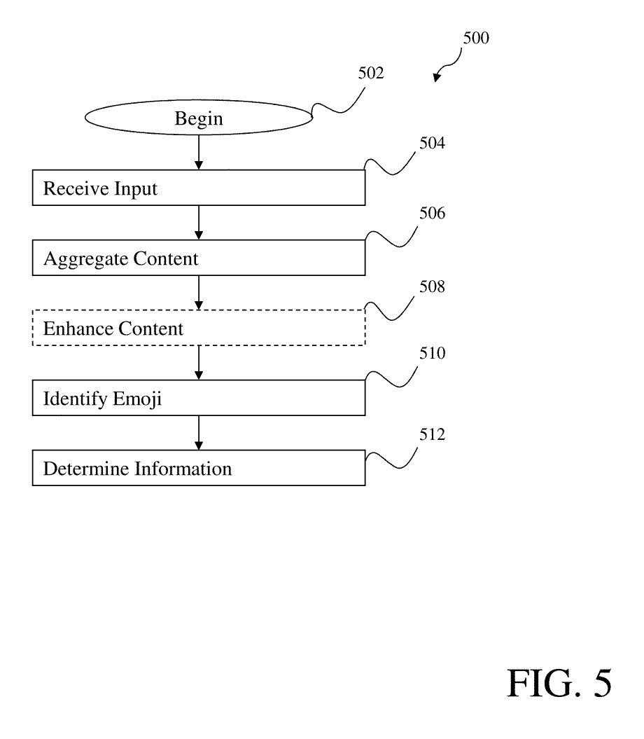

In further embodiments, Emojis included within one or more social media posts may be analyzed to learn more about the author of the social media post, and provide author information regarding the author to a user 102 or a client 130 of the service 101. Such an embodiment is further described with reference to the block diagram shown in FIG. 5. Turning to FIG. 5, shown is an example process flow for determining author information, according to various examples. In various implementations, the processes discussed with reference to FIG. 5 may be performed by a system for providing geographically delineated content, author information, influencer information, or a geographic location for a defined audience, such as the service 101 discussed above with reference to FIG. 1. FIG. 5 is described with continuing reference to FIG. 1.

As shown, in FIG. 5 the computer-executed process may include acts of receiving an input defining a geographic location, aggregating geographically delineated content for an audience within the geographic location, identifying one or more Emoji associated individual media posts, and determining author information. In further embodiments, the computer-executed process 500 may include the act of enhancing aggregated geographically delineated content. Such acts may include those processes executed by components of the service 101 and described herein with reference to acts 404, 406, 408, and 410 of FIG. 4. For example, block 504 may include those acts discussed with reference to block 404, block 506 may include those acts discussed with reference to block 406, block 508 may include those acts discussed with reference to block 408, and block 510 may include those acts discussed with reference to block 410.

At block 502 one or more components of the service 101, such as the enrichment component 134 is configured to determine author information for authors within the geographic location based at least on the identified one or more Emojis. For example, author information may consist of demographic information such as age, sex, and income. In further embodiments, demographic information may include any qualities that define a specific group of people.

In various embodiments, one or more components of the service 101 are configured to analyze the correlation between use of Emojis, and in particular, individual Emojis, with particular author information (e.g., demographic information). In at least one implementation, the enrichment component 134 is configured to perform machine learning, such as natural language processing, to determine the correlation between age groups and Emojis. For example, the enrichment component 134 may determine that authors between the age group of 20-29 can be identified by the inclusion of an Emoji of the animal genre within a media post. Similarly, the enrichment component may be configured to determine that authors having an income of $25 k-$50 k can be identified by the inclusion of an Emoji of the weather genre within a media post. Responsive to such an analysis, in block 502 of FIG. 5, one or more components of the service 101 are configured to provide author information based on the identified Emoji.

### Example Computing Device Implementations

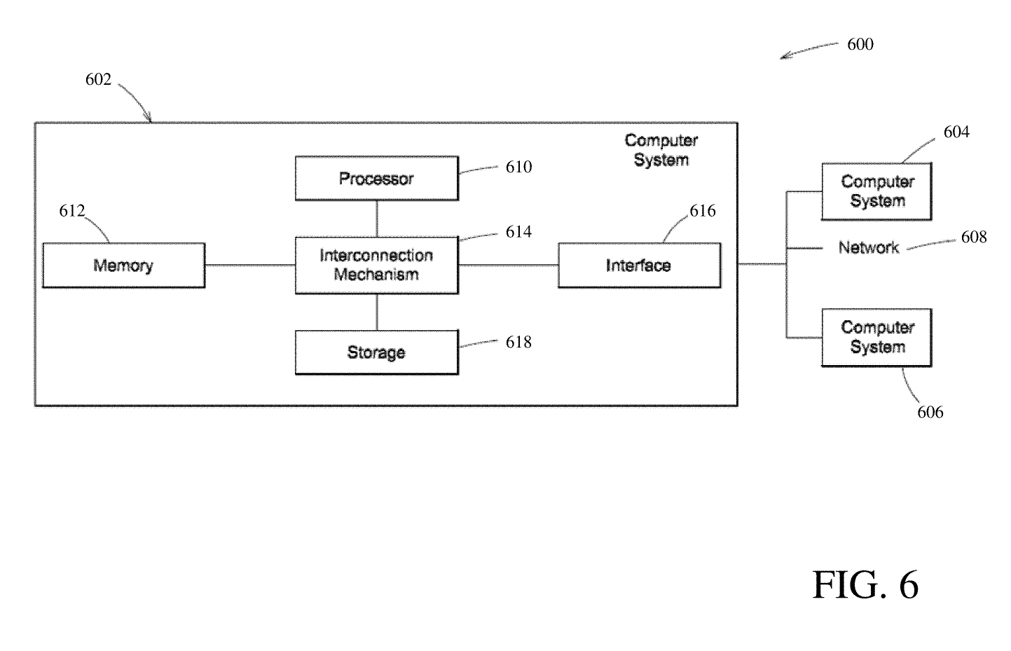

Referring to FIG. 6, there is illustrated a block diagram of a distributed computer system 600, in which various aspects and functions are practiced. As shown, the distributed computer system 600 includes one or more computer systems that exchange information. More specifically, the distributed computer system 600 includes computer systems 602, 604, and 606. As shown, the computer systems 602, 604, and 606 are interconnected by, and may exchange data through, a communication network 608. The network 608 may include any communication network through which computer systems may exchange data. To exchange data using the network 608, the computer systems 602, 604, and 606 and the network 608 may use various methods, protocols and standards to communicate information, including, among others, Fibre Channel, Ethernet, Wireless Ethernet, Bluetooth, IP, IPV6, TCP/IP, UDP, DTN, HTTP, FTP, SMS, MMS, SS7, JSON, SOAP, CORBA, REST, and Web Services. To ensure data transfer is secure, the computer systems 602, 604, and 606 may transmit data via the network 608 using a variety of security measures including, for example, SSL or VPN technologies. While the distributed computer system 600 illustrates three networked computer systems, the distributed computer system 600 is not so limited and may include any number of computer systems and computing devices, networked using any medium and communication protocol.

As illustrated in FIG. 6, the computer system 602 includes a processor 610, a memory 612, an interconnection element 614, an interface 616 and data storage element 618. To implement at least some of the aspects, functions, and processes disclosed herein, the processor 610 performs a series of instructions that result in manipulated data. The processor 610 may be any type of processor, multiprocessor or controller. Example processors may include a commercially available processor such as an Intel Xeon, Itanium, or Core processor; an AMD Opteron processor; an Apple A4 or A5 processor; an IBM Power5+ processor; an IBM mainframe chip; or a quantum computer. The processor 610 is connected to other system components, including one or more memory devices 612, by the interconnection element 614.

The memory 612 stores programs (e.g., sequences of instructions coded to be executable by the processor 610) and data during operation of the computer system 602. Thus, the memory 612 may be a relatively high performance, volatile, random access memory such as a dynamic random access memory (“DRAM”) or static memory (“SRAM”). However, the memory 612 may include any device for storing data, such as a disk drive or other nonvolatile storage device. Various examples may organize the memory 612 into particularized and, in some cases, unique structures to perform the functions disclosed herein. These data structures may be sized and organized to store values for particular data and types of data.

Components of the computer system 602 are coupled by an interconnection element such as the interconnection element 614. The interconnection element 614 may include any communication coupling between system components such as one or more physical busses in conformance with specialized or standard computing bus technologies such as IDE, SCSI, PCI and InfiniBand. The interconnection element 614 enables communications, including instructions and data, to be exchanged between system components of the computer system 602.

The computer system 602 also includes one or more interface devices 616 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 602 to exchange information and to communicate with external entities, such as users and other systems.

The data storage element 618 includes a computer readable and writeable nonvolatile, or non-transitory, data storage medium in which instructions are stored that define a program or other object that is executed by the processor 610. The data storage element 618 also may include information that is recorded, on or in, the medium, and that is processed by the processor 610 during execution of the program. More specifically, the information may be stored in one or more data structures specifically configured to conserve storage space or increase data exchange performance.

The instructions may be persistently stored as encoded signals, and the instructions may cause the processor 610 to perform any of the functions described herein. The medium may, for example, be optical disk, magnetic disk or flash memory, among others. In operation, the processor 610 or some other controller causes data to be read from the nonvolatile recording medium into another memory, such as the memory 612, that allows for faster access to the information by the processor 610 than does the storage medium included in the data storage element 618. The memory may be located in the data storage element 618 or in the memory 612, however, the processor 610 manipulates the data within the memory, and then copies the data to the storage medium associated with the data storage element 618 after processing is completed. A variety of components may manage data movement between the storage medium and other memory elements and examples are not limited to particular data management components. Further, examples are not limited to a particular memory system or data storage system.

Although the computer system 602 is shown by way of example as one type of computer system upon which various aspects and functions may be practiced, aspects and functions are not limited to being implemented on the computer system 602 as shown in FIG. 6. Various aspects and functions may be practiced on one or more computers having a different architectures or components than that shown in FIG. 6. For instance, the computer system 602 may include specially programmed, special-purpose hardware, such as an application-specific integrated circuit (“ASIC”) tailored to perform a particular operation disclosed herein. In another specially-designed system, both hardware and software may be used to provide a new tool that performs one or more aspects of the present invention. Another example may perform the same operation using a grid of several general-purpose computing devices running MAC OS System X with Intel processors and several specialized computing devices running proprietary hardware and operating systems.

The computer system 602 may be a computer system including an operating system that manages at least a portion of the hardware elements included in the computer system 602. In some examples, a processor or controller, such as the processor 610, executes an operating system. Examples of a particular operating system that may be executed include a Windows-based operating system, such as, Windows Phone, Windows 7, or Windows 8 operating systems, available from the Microsoft Corporation, Android operating system available from Google, Blackberry operating system available from Blackberry Limited, a MAC OS System X operating system or an iOS operating system available from Apple, one of many Linux-based operating system distributions, for example, the Enterprise Linux operating system available from Red Hat Inc., or UNIX operating systems available from various sources. Many other operating systems may be used, and examples are not limited to any particular operating system.

The processor 610 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, Ruby, Objective-C, Java, C++, C# (C-Sharp), Python, or JavaScript. Other object-oriented programming languages may also be used. Alternatively, functional, scripting, or logical programming languages may be used.

Additionally, various aspects and functions may be implemented in a non-programmed environment. For example, documents created in HTML, XML or other formats, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements (e.g., specialized hardware, executable code, data structures or objects) that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

### Example Interfaces

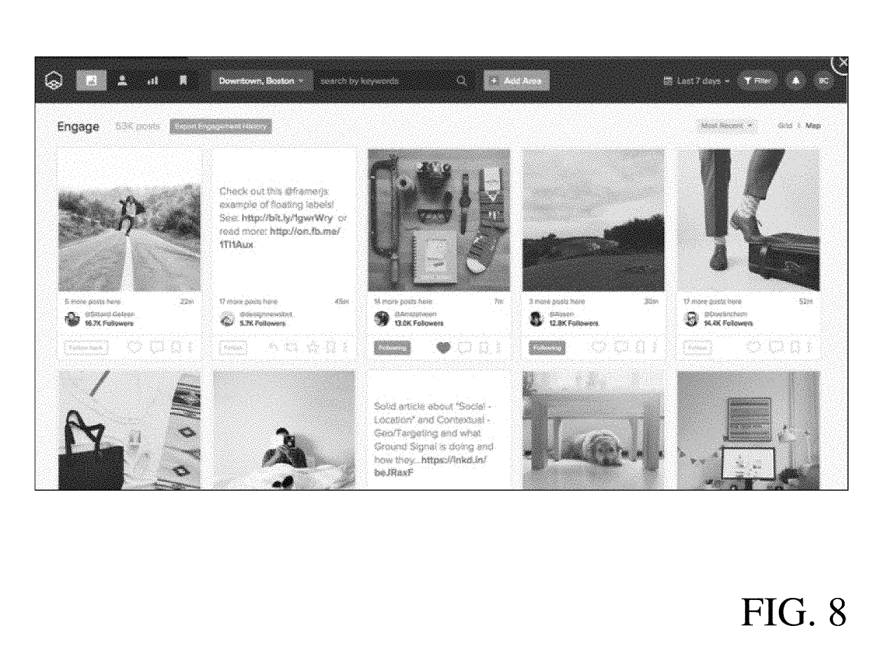

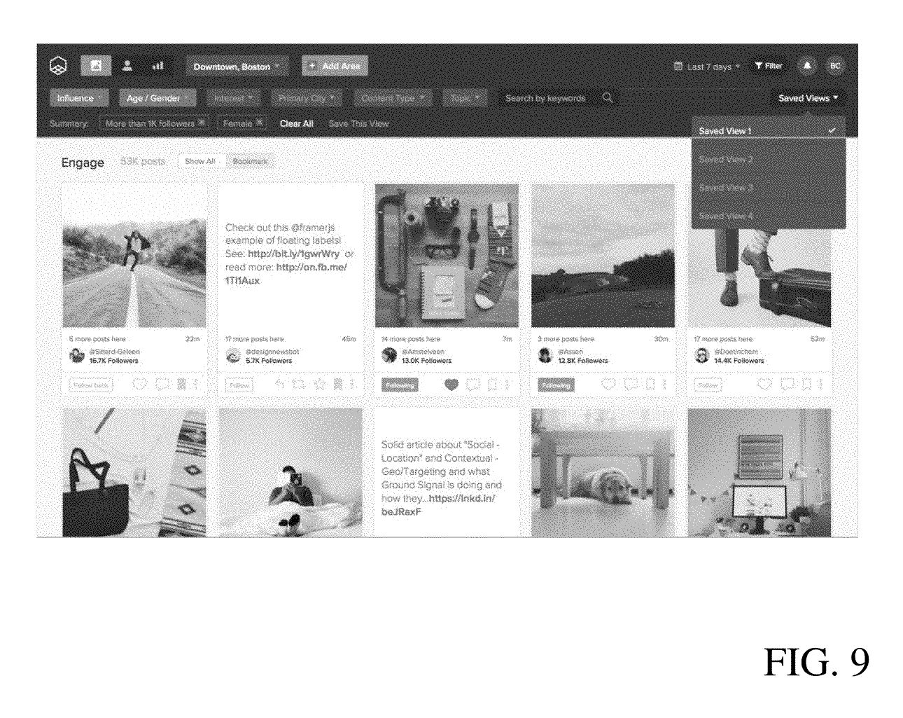

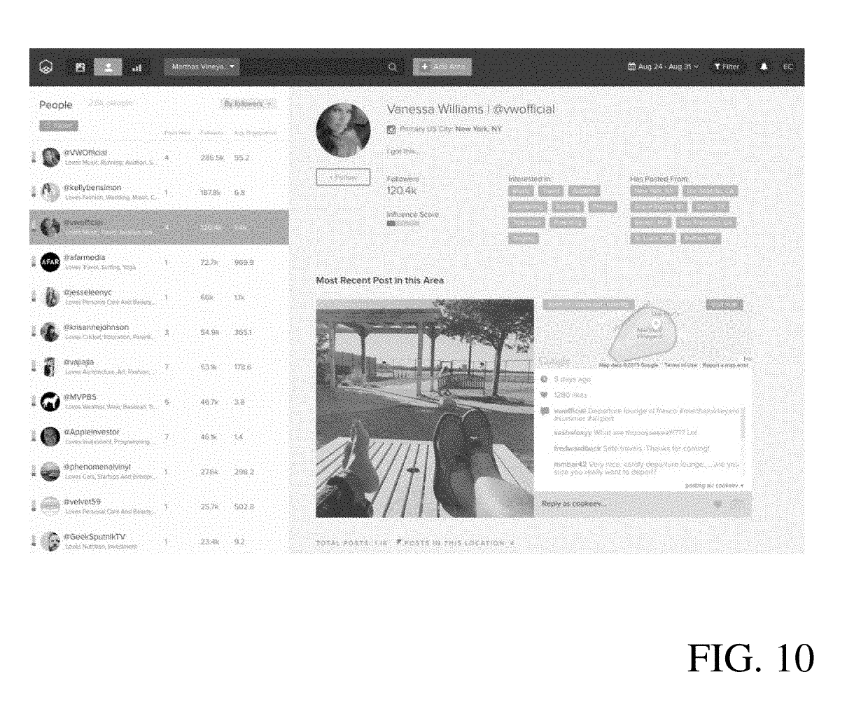

FIGS. 7-10 show example user interfaces according to various aspects described herein. In particular, FIG. 7 shows a user interface for providing an image of an identified geographic location, according to various embodiments. FIG. 8 shows a user interface for providing geographically delineated content associated with one or more identified geographic locations. FIG. 9 shows a further depiction of the user interface of FIG. 8, in which one or more views are provided to a user of the user interface. FIG. 10 shows a user interface for providing author information corresponding to an author within an identified geographic location. In various aspects and embodiments, the user interfaces discussed with reference to FIGS. 7-10 may be implemented and controlled through a location-based service, such as the service 101 discussed above with reference to FIG. 1.

FIG. 7 shows an example user interface for providing an image of an identified geographic location. In various embodiments, the identified geographic location is based on an audience or a topic defined by a user or client, as discussed above. FIG. 7 shows the user interface as further providing author information, influencer information, or geographically delineated content associated with the identified geographic location. As shown in FIG. 7, in various embodiments one or more user interfaces may include an image (e.g., map) of the identified geographic location. For example, the user interface of FIG. 7 is shown as providing an image of the identified geographic location of Martha's Vineyard. While shown as a map, the image may include a street map, a satellite image, a mass transit map, or any other geographic depiction. The identified geographic location may be indicated in the map by a polygon or other visual representation outlining the boundaries of the identified geographic location. One or more navigation indicators provided by the user interface of FIG. 7, permit the user to zoom-in or zoom-out on the shown map. In further embodiments, responsive to selection and manipulation of the shown polygon, the user interface is configured to move, re-shape, or otherwise change the identified geographic area. Accordingly, in various embodiments, the user interface first provides the user or client of the user interface with an identified geographic location based on a defined audience. The user interface may then re-display or re-shape that identified geographic location responsive to selection and movement of the shown polygon.

The user interface of FIG. 7 also may provide one or more indicators layered over the displayed image of the identified geographic location. While in various embodiments the indicators may correspond to a heatmap, in at least one implementation the indicators may indicate the location associated with a media post, an author, or an influencer. In many instances, the indicators correspond to social media posts generated by authors within the defined audience. Each indicator may be personalized to the particular author or influencer that generated the respective post. For example, in FIG. 7 each indicator corresponds to an avatar of an associated author. In further embodiments, each indicator may correspond to multiple media posts, a group of authors, a group of influencers, or any combination of the foregoing. Responsive to selection of one or more indicators, the user interface is configured to display the media post, author information, or influencer information associated with that indicator. In further embodiments, the interface may further provide one or more view indicators permitting the user to zoom-in or zoom-out on the image of the identified geographic location.

FIG. 8 shows a user interface for providing geographically delineated content generated by one or more authors within an identified geographic location. Once a geographic location has been identified, one or more user interfaces, such as the user interface shown in FIG. 8, may provide geographically delineated content, author information, or influencer information for that identified area. Various embodiments appreciate that the user or client may be interested in the social activity, or authors associated with a geographic location, once that location has been identified. Such embodiments permit the user or client to learn more about a desired author or audience. In one embodiment, the shown user interface may display geographically delineated content including individual media posts as a plurality of cards, each card including author information corresponding to the author that generated the respective media post. While the user interface of FIG. 8 shows an arrangement of cards in rows and columns, any arrangement may be used. Further, arrangements other than cards may be used to display geographically delineated content, author information, or influencer information, such as a grid or slideshow.

As shown, each card provided by the user interface of FIG. 8 may have the content of the media post (e.g., an image, text, hyperlink), author information, and one or more options for the user of the interface to interact with the author of the media post. For example, the user interface shows a first card as including an image, the volume of posts from the author associated with the identified geographic location, an indication of the time the media post was created, an avatar of the author, a username of the author, and the author's follower count. In further embodiments, the user interface of FIG. 8 may further include an indication of whether the user is following the author, a favorite indicator, a message indicator, and one or more card expansion window indicators. The user interface of FIG. 8 also provides one or more indicators of the location for which the geographically delineated content, author information, or influencer information is displayed. This for example, may be displayed in a drop down menu along a menu bar of the user interface. Responsive to activation of the drop down menu, the user interface may display one or more previously identified geographic locations and geographically delineated content, author information, or influencer information associated therewith. Such an embodiment permits the user of the interface to efficiently navigate between one or more previously identified geographic locations. This may be advantageous when more than one geographic location has been identified for a particular audience.

FIG. 9 shows a further depiction of the user interface of FIG. 8, in which one or more views are provided to a user of the user interface. In various embodiments, the user interface provides one or more filters. In various embodiments, the user interface is configured to display one or more expansion windows responsive to selection of a filter. Filters are shown in the user interface of FIG. 9 displayed along a menu bar. For example, FIG. 9 shows the user interface providing a filter corresponding to Influence, Age/Gender, Interest, Primary City, Content Type, and Topic. A search box may also permit the user to search the geographically delineated content for the identified geographic location based on keyword. Each expansion window corresponding to a filter may include at least one option for further filtering the displayed geographically delineated content, author information, influencer information, or metrics. For example, the expansion window for the Age/Gender filter may include the options 20-29, 40-49, 30-39, and 50+ age options. Filter options permit the user of the interface to further define the audience once a geographic location has been identified. Responsive to the activation of one or more filters, the user interface is configured to re-display or re-arrange the provided geographically delineated content, author information, or influencer information. In various embodiments, the user interface may provide an indicator, the activation of which permits the user to save a current display of geographically delineated content, author information, or influencer information. For example, the user interface of FIG. 9 includes a “Save This View” indicator positioned within the menu bar.

In various embodiments, the user interface may include a drop down menu of saved views. The menu of views is also shown along the menu bar of the user interface of FIG. 9. Responsive to activation of one of the views, the user interface is configured to recall and redisplay the geographically delineated content, author information, or influencer information associated with that saved view. Such an embodiment permits the user of the interface to efficiently and quickly switch between one or more filtered views of content pertaining to a defined audience for an identified geographic location.

FIG. 10 shows one example embodiment of a user interface for providing author information corresponding to authors within an identified location. In various aspects and embodiments, similar user interfaces may be displayed for providing influencer information. As shown in FIG. 10, the interface may provide a display of individual authors within an identified geographic location. For example, individual authors may be arranged in a list or other organized arrangement. Responsive to selection of one or more of the displayed authors, the user interface shows an expanded view of the selected author. FIG. 10 shows an expanded view of the selected author. The user interface may permit the user to filter and control the arrangement of authors, by number of followers, for example, or any other suitable author information. Accordingly, in various embodiments, once a geographic location has been identified for a defined audience, the user interface may provide author information including details about authors located within that identified geographic location.

The user interface may provide more detailed author information for the selected author than that provided in the arranged list of authors. Such author information may include any author information as discussed herein. FIG. 10 shows the provided author information as including at least interests, an influence score, the number of authors following the specified author, location history, a most recently posted social media post for the identified geographic location, an image of the geographic location associated with the media post, a post volume, and a post volume for the identified geographic location. Also shown in FIG. 10, the user interface may provide an image or avatar of the author, the author's name, a username of the author, and the author's primary location, among other identifying author information. The user interface may further provide one or more links that connect the user to an author profile on one or more social media provider platforms. The user interface of FIG. 10 may further permit the user to navigate between authors provided in the displayed list of authors.

Accordingly, embodiments disclosed herein include services, application systems, applications, and methods for identifying a geographic location for a desired audience and providing geographically delineated content or author information. Geographically delineated content can include social media content that is relevant to one or more geographic locations, and information associated with the author whom generated the content. For example content can include text, photographs, videos, and/or audio files. Although social media content providers as described herein include social media platforms such as Twitter, Facebook, MySpace, LinkedIn, Pinterest and Tumblr, in further embodiments, providers can include any social media content provider as is understood in the art.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only.

What is claimed is:

1. A computer system comprising:
an interface configured to receive an input defining at least one audience;
a location-based service including a distributed computer system having at least one processor in data communication with the interface;
a delineation component adapted to aggregate geographically delineated content including a plurality of social media posts each generated by an author based at least in part on the input defining at least one audience, and wherein each post has an associated geographic location;
a relation component adapted to identify a geographic location associated with the audience based at least in part on the geographically delineated content; and
a communication component adapted to provide the identified geographic location.

2. The computer system according to claim 1, wherein the geographic location includes a plurality of geographic locations.

3. The computer system according to claim 1, wherein the system is configured to receive and index the geographically delineated content based the associated geographic location of each social media post.

4. The computer system according to claim 3, further comprising an enrichment component to aggregate author profile information based at least in part on the input defining at least one audience.

5. The computer system according to claim 4, wherein the relation component is further adapted to identify the geographic location associated with the audience based at least in part on the author profile information.

6. The computer system according to claim 1, wherein the input defining at least one audience includes a personality type.

7. The computer system according to claim 1, wherein the input defining at least one audience includes author characteristics.

8. The computer system according to claim 1, further comprising an influencer component adapted to determine influencer information for the geographic location.

9. The computer system according to claim 1, wherein the audience includes at least one author.

10. A computer-executed method comprising:
receiving an input defining at least one audience;
aggregating geographically delineated content including a plurality of social media posts each generated by an author based at least in part on the input, wherein each post has an associated geographic location;
identifying a geographic location associated with the audience based at least in part on the geographically delineated content; and
providing the identified geographic location.

11. The computer-executed method of claim 10, wherein the geographic location includes a plurality of geographic locations.

12. The computer-executed method of claim 10, further comprising receiving geographically delineated content and indexing the geographically delineated content based on the associated geographic location of each social media post.

13. The computer-executed method of claim 10, further comprising aggregating author profile information based at least in part on the input defining at least one audience.

14. The computer-executed method of claim 13, wherein identifying the geographic location associated with the audience is further based on the author profile information.

15. The computer-executed method of claim 10, wherein the input defining at least one audience includes a personality type.

16. The computer-executed method of claim 10, wherein the input defining at least one audience includes author characteristics.

17. The computer-executed method of claim 15, further comprising determining influencer information for the geographic location.

18. The computer-executed method of claim 17, wherein the audience includes at least one author.

19. A computer system comprising:
an interface configured to receive an input defining a geographic location;
a location-based service including a distributed computer system having at least one processor in data communication with the interface;
a delineation component adapted to aggregate geographically delineated content for an audience within the geographic location, the aggregated geographically delineated content including a plurality of social media posts each generated by an author within the geographic location;
an enrichment component adapted to identify social media posts of the plurality of social media posts including a first Emoji; and
a trend component adapted to determine a sentiment associated with the first Emoji based on the at least content associated with the identified social media posts including the first Emoji.

20. A computer system comprising:
an interface configured to receive an input defining a geographic location;
a location-based service including a distributed computer system having at least one processor in data communication with the interface;
a delineation component adapted to aggregate geographically delineated content for an audience within the geographic location, the aggregated geographically delineated content including a plurality of social media posts each generated by an author within the geographic location; and
an enrichment component adapted to identify one or more Emoji associated with individual media posts of the plurality of media posts, and determine author information for author within the geographic location based at least on the identified one or more Emoji.

21.-23. (canceled)
